(19) United States
(12) Patent Application Publication
(10) Pub. No.: US 2025/0132544 A1
(43) Pub. Date: Apr. 24, 2025

(54) Boom Mountable Modular Hot Line Jib Assembly

(71) Applicant: Larry Dale Ewert, Lake Country (CA)

(72) Inventor: Larry Dale Ewert, Lake Country (CA)

(73) Assignee: POWERGRID TOOLS LTD, Lake Country, BC (CA)

(21) Appl. No.: 18/766,435

(22) Filed: Jul. 8, 2024

(30) Foreign Application Priority Data
Jul. 10, 2023 (CA) 3,206,006

(51) Int. Cl. H02G 1/02; B66F 17/00

(52) U.S. Cl. CPC H02G 1/02; B66F 17/006

(57) ABSTRACT

The present invention relates to a modular hot line jib assembly with two opposite facing coaxial booms removably mountable to a boom lift and operated by a radio transmitter. The present invention allows temporary handling of energised powerline conductors of multiple configurations for installation, maintenance, and storm and disaster repair procedures. The present invention also provides modular sub-assemblies which can be installed at the vehicle home base allowing the vehicle to travel with job-related sub-assemblies pre-installed.

The present invention provides multiple safety and functionality improvements for enhanced electrical safety of line crew workers including electrical insulation and structural capacity monitoring. Considering that energized work is fraught with fatal accidents, there is also a requirement for electrically insulated equipment which provides a Minimum Approach Distance Barrier to physically restrict energised electrical circuits from creating phase to ground electrical circuits and to reduce possibility of electrical contacts and save lives.

### A. SUMMARY OF THE INVENTION

In a first embodiment as shown in FIG. 6 hereby disclosed, the modular hot line jib assembly is composed of only six sub-assemblies. The primary articulating jib sub-assembly, assembly, a secondary pin-on jib sub-assembly, a MAD “Minimum Approach Distance” Barrier sub-assembly, two boom clamping sleeve conductor holder sub-assemblies and a MAD conductor holder sub-assembly.

The primary articulating jib sub-assembly is comprised of a mounting bracket for a rotary actuator, a rotary actuator, a primary boom base socket for the primary boom which extends from the primary boom base socket to a primary boom end socket. The primary boom base socket includes four mounting holes to pivotably attach a secondary pin-on jib sub-assembly about a vertical axis. The mounting holes are aligned vertically and coaxially in pairs so that two can function as a coaxial hinge and two can function as coaxial locking pins. The primary boom end socket includes a plurality of positioning holes which correspond with the optional attachments which are listed in the applicant's previous patent application per Applicant Reference Number 2023BOC_CS and CIPO Reference Number 663257740017817150.

The modular hot line jib assembly is also comprised of a secondary pin-on jib sub-assembly which is comprised of a secondary jib adapter socket for the second boom and a second boom which extends from the secondary jib adapter socket to a second boom end socket. The secondary jib adapter socket includes matching mounting holes to pivotably attach the primary boom base socket of the primary articulating jib sub-assembly about a vertical pivot axis. Both the primary articulating jib sub-assembly and the secondary pin-on jib sub-assemblies include end seals, desiccants and are connected to a very sensitive voltage leakage monitor system which will allow the operator to monitor real-time electrical leakage of the modular hot line jib assembly and enhance electrical safety.

The modular hot line jib assembly is also comprised of a MAD Barrier sub-assembly which is comprised of two MAD boom clamping sleeves releasably attached to telescopic insulated support posts which are releasably attached to electrically insulating crossbeam sections. Said crossbeam sections are pivotably attached at the midpoint about a vertical pivot axis which corresponds with the vertical pivot axis between the primary boom base socket and the secondary jib adapter socket. The lengths of the electrically insulating crossbeam sections may extend beyond the MAD clearance distance requirements per work site requirements.

One MAD boom clamping sleeve is releasably connected to the first boom of the primary articulating jib sub-assembly and one MAD boom clamping sleeve is releasably connected to the second boom of the secondary pin-on jib sub-assembly. Both MAD boom clamping sleeves are positioned with substantially equal spacing from their respective leakage monitoring shields which is equal to or exceeds the phase to ground MAD distance as listed in the appropriate electrical standard. Each of the MAD boom clamping sleeves are releasably connected to an electrically insulating telescopic support post at the proximal end and releasably connected to the electrically insulating crossbeam sections at the distal end. Said electrically insulating telescopic support posts allow vertical movement of the electrically insulating crossbeam sections to the recommended MAD clearance distance from the primary boom base socket which eliminates the possibility of an electrical path to ground through the boom lift. The electrically insulating crossbeam sections also provide a physical barrier to prevent any energised conductors from encroaching within the MAD clearance region and they also increase the phase-to-phase leakage distance for additional voltage leakage safety. The electrically insulating telescopic support posts also retract to minimise the overall height of the electrically insulating crossbeam sections and allow storage under the boom lift for travel. Said retraction function avoids the requirement for removal of the MAD Barrier sub-assembly due to physical size constraints.

The MAD Barrier also comprises a pair of electrically insulating crossbeam sections which consists of two electrically insulating crossbeams which have an offset vertical pivot axis at the midpoint. The offset vertical pivot axis is in vertical alignment with the vertical pivot axis between the primary and secondary booms. Said offset pivot is comprised of an end socket with upper and lower pivot plates with a vertical pivot hole on one side and a lock pin hole on the other. The lock pin between the primary articulating jib sub-assembly and the secondary pin-on jib sub-assembly and the lock pin between the two beams of the MAD Barrier are coaxial and must be removed at the same time to allow the secondary pin-on jib sub-assembly to pivot around their coaxial vertical axis and stow beside the primary articulating jib sub-assembly. Once stowed, the proximal ends of both jib sub-assemblies may be supported by the boom lift boom support at the rear of the flat deck and the distal ends of both jib sub-assemblies can be releasably secured to the jib support.

Each of the electrically insulating crossbeams of the MAD Barrier is also fixedly attached to a MAD End Socket Polar Array at the distal end of the electrically insulated crossbeam. Said MAD End Socket Polar Array includes a substantially horizontal axis of rotation extending substantially laterally across the electrically insulated crossbeam and equipped with a plurality of holes to allow attachments to be positionally located by a positional pin relative to said electrically insulated crossmember in a substantially vertical plane.

In the first embodiment, shown in FIG. 7, the modular hot line jib assembly is also comprised of a MAD conductor holder sub-assembly. Said MAD conductor holder sub-assembly is releasably attached to a mount on the top of one of the electrically insulating crossbeam sections by a support bracket which is pivotably attached to a conductor holder means by a bearing. Conductor holder assemblies which articulate, and pivot are also commercially available.

The modular hot line jib assembly shown in FIG. 7, also comprises at least two boom clamping sleeve conductor holder sub-assemblies. Said boom clamping sleeve conductor holder sub-assemblies are each comprised of a boom clamping sleeve which may be releasably mounted onto a support bracket which is pivotably attached to a conductor holder means by a bearing.

One boom clamping sleeve conductor holder sub-assembly is mounted on each of the primary and secondary booms of the modular hot line jib assembly. Said boom clamping sleeve conductor holder sub-assemblies are positioned manually while at ground level along the primary and secondary booms to match the distances between the powerline conductors at the work site before deploying the modular hot line jib assembly.

In a second embodiment as shown in FIG. 6, hereby disclosed, the modular hot line jib assembly is also composed of only six sub-assemblies. The primary articulating jib sub-assembly, a secondary pin-on jib sub-assembly, a MAD Barrier sub-assembly, two boom clamping sleeves with electrically insulated telescopic support post sub-assemblies and a MAD conductor holder sub-assembly.

The two boom clamping sleeves with electrically insulated telescopic support post sub-assemblies are each comprised of a releasably attached boom clamping sleeve which is releasably attached to either the primary or secondary boom of the modular hot line jib assembly. The boom clamping sleeve is also releasably attached to an electrically insulated telescopic support post at the proximal end. The distal end of the electrically insulating support post is releasably attached by mechanical fasteners (not shown) to a support bracket by a two-pin connector equipped with pin retainers. Said support bracket may be mounted at various angles relative to the top of the primary articulating jib sub-assembly by selecting the appropriate pin holes for the two-pin connector which change the angle in a substantially vertical plane. The support bracket is also attached by a center mounted mechanical fastener through a bearing to conductor holder. The bearing allows rotational movement of the conductor holder to allow alignment with the powerlines.

In a third embodiment as shown in FIG. 8, hereby disclosed, the modular hot line jib assembly is also composed of only six sub-assemblies. The primary articulating jib sub-assembly, a secondary pin-on jib sub-assembly, a MAD Barrier sub-assembly, two boom clamping sleeve conductor holder sub-assemblies and a MAD electrically insulated telescopic support post sub-assembly. All components are installed at the vehicle home base and stowed under the boom lift for travel and deployment after the vehicle reaches the work area.

The MAD electrically insulated telescopic support post sub-assembly is releasably attached at the proximal end to an electrically insulated telescopic support post sub-assembly on the top of one of the electrically insulating crossbeam sections and by a support bracket which is pivotably attached to a conductor holder means by a bearing at the distal end. Said boom clamping sleeve conductor holder sub-assemblies and the MAD electrically insulated telescopic support post sub-assembly are positioned manually at ground level along the primary and secondary booms to match the distances between the powerline conductors at the work site before deploying the modular hot line jib assembly.

In a fourth embodiment as shown in FIG. 9, hereby disclosed, the modular hot line jib assembly is also composed of only six sub-assemblies. The primary articulating jib sub-assembly, a secondary pin-on jib sub-assembly, a MAD Barrier sub-assembly, two boom clamping sleeves with electrically insulated telescopic support post sub-assemblies and a MAD electrically insulated telescopic support post sub-assembly. All components are installed at the vehicle home base and stowed under the boom lift for travel and deployment after the vehicle reaches the work area.

Said boom clamping sleeves with electrically insulated telescopic support post sub-assemblies and the MAD electrically insulated telescopic support post sub-assembly are positioned manually at ground level along the primary and secondary booms to match the distances between the powerline conductors at the work site before deploying the modular hot line jib assembly.

In a fifth embodiment as shown in FIG. 10, hereby disclosed, the modular hot line jib assembly is composed of only eight sub-assemblies. The primary articulating jib sub-assembly, a secondary pin-on jib sub-assembly, a MAD Barrier sub-assembly, two boom clamping sleeve conductor holder sub-assemblies and a MAD conductor holder sub-assembly and two MAD Articulating Conductor Holder Sub-Assemblies. All components are installed at the vehicle home base and stowed under the boom lift for travel and deployment after the vehicle reaches the work area.

Said MAD Articulating Conductor Holder Sub-Assemblies are each pivotably attached to a MAD End Socket Polar Array at the distal ends of the electrically insulated crossbeams. Said MAD Articulating Conductor Holder Sub-Assemblies are each comprised of a MAD Pivot Support Tube which includes a substantially horizontal axis of rotation extending substantially laterally across the MAD End Socket Polar Array and a positioning hole to be positionally located by a positional pin relative to said electrically insulated crossmember in a substantially vertical plane.

Said boom clamping sleeve sub-assemblies and said MAD electrically insulated telescopic support post sub-assembly are positioned manually at ground level along the primary and secondary booms to match the distances between the powerline conductors at the work site before deploying the modular hot line jib assembly.

In a sixth embodiment as shown in FIG. 11, hereby disclosed, the modular hot line jib assembly is also comprised of only eight sub-assemblies. The primary articulating jib sub-assembly, a secondary pin-on jib sub-assembly, a MAD Barrier sub-assembly, two boom clamping sleeve conductor holder sub-assemblies and a MAD electrically insulated telescopic support post sub-assembly and two MAD Articulating Conductor Holder Sub-Assemblies. All components are installed at the vehicle home base and stowed under the boom lift for travel and deployment after the vehicle reaches the work area.

In a seventh embodiment as shown in FIG. 12, hereby disclosed, the modular hot line jib assembly is also comprised of only eight sub-assemblies. The primary articulating jib sub-assembly, a secondary pin-on jib sub-assembly, a MAD Barrier sub-assembly, a MAD conductor holder sub-assembly, two boom clamping sleeves with electrically insulated telescopic support post sub-assemblies and two MAD Articulating Telescopic Insulated Post Sub-Assemblies. All components are installed at the vehicle home base and stowed under the boom lift for travel and deployment after the vehicle reaches the work area.

Said MAD Articulating Telescopic Insulated Post Sub-Assemblies are each pivotably attached to a MAD End Socket Polar Array at the distal ends of the electrically insulated crossbeams. Said MAD Articulating Telescopic Insulated Post Sub-Assemblies are each comprised of a MAD Pivot Support Tube which includes a substantially horizontal axis of rotation extending substantially laterally across the MAD End Socket Polar Array and a positioning hole to be positionally located by a positional pin relative to said electrically insulated crossmember in a substantially vertical plane. Said MAD Pivot Support Tubes are releasably attached at the proximal end to an electrically insulated telescopic support post and support bracket and conductor holder means sub-assembly at the distal end. Said support bracket is pivotably attached to a conductor holder means by a bearing.

In an eighth embodiment as shown in FIG. 13, hereby disclosed, the modular hot line jib assembly is also comprised of only eight sub-assemblies. The primary articulating jib sub-assembly, a secondary pin-on jib sub-assembly, a MAD Barrier sub-assembly, two boom clamping sleeves with electrically insulated telescopic support post sub-assemblies and a MAD electrically insulated telescopic support post sub-assemblies and two MAD Articulating Telescopic Insulated Post Sub-Assemblies.

All embodiments of the modular hot line jib assembly listed above allow their components to be installed at the vehicle home base and stowed under the boom lift for travel and deployment after the vehicle reaches the work area. Said embodiments also allow boom clamping sleeves with electrically insulated telescopic support posts sub-assemblies or with conductor holder sub-assemblies to be positioned manually at ground level along the primary and secondary booms to match the distances between the powerline conductors at the work site before deploying the modular hot line jib assembly.

### B. BRIEF DESCRIPTION OF DRAWINGS

The disclosed invention will be described with reference to the accompanying drawings, which show important sample embodiments, wherein.

FIG. 1A is a perspective view showing an improved modular jib assembly releasably. attached to a boom lift and positioned to illustrate the jib supporting three transmission powerlines in a vertical configuration.

FIG. 1B is a perspective view showing an improved modular jib assembly releasably attached to a boom lift and positioned to illustrate the jib supporting three transmission powerlines in a horizontal configuration.

FIG. 2 is a perspective view of the driver side showing an improved modular jib assembly releasably attached to a boom lift and positioned in the stowed-over configuration which allows travel at slow speeds while off-highway.

FIG. 3A is a perspective view of the driver side showing an improved modular jib assembly releasably attached to a boom lift and positioned in the stowed-under configuration which allows travel at slow speeds while off-highway.

FIG. 3B is a perspective view of the passenger side showing an improved modular jib assembly releasably attached to a boom lift and positioned in the stowed-under configuration, also showing the side-stow position of the secondary boom sub-assembly. This configuration allows travel on or off-highway.

FIG. 4A is a perspective view of the primary jib sub-assembly of an improved modular jib assembly removably mountable to a boom lift.

FIG. 4B is a perspective view of the secondary jib sub-assembly of an improved modular jib assembly removably mountable to a boom lift.

FIG. 5 is a perspective view of the MAD Barrier sub-assembly “Minimum Approach Distance” Barrier sub-assembly of an improved modular jib assembly removably mountable to a boom lift.

FIG. 6 is a perspective view of an improved modular jib assembly removably mountable to a boom lift with the addition of the MAD Barrier sub-assembly including a MAD conductor holder sub-assembly and two boom clamping sleeves with electrically insulated telescopic support post sub-assemblies.

FIG. 7 is a perspective view of an improved modular jib assembly removably mountable to a boom lift with the addition of the MAD Barrier sub-assembly including a MAD conductor holder sub-assembly and two boom clamping sleeves with conductor holder sub-assemblies.

FIG. 8 is a perspective view of an improved modular jib assembly removably mountable to a boom lift with the addition of the MAD Barrier sub-assembly including a MAD electrically insulated telescopic support post sub-assembly and two boom clamping sleeves with conductor holder sub-assemblies.

FIG. 9 is a perspective view of an improved modular jib assembly removably mountable to a boom lift with the addition of the MAD Barrier sub-assembly including a MAD electrically insulated telescopic support post sub-assembly and two boom clamping sleeves with electrically insulated telescopic support post sub-assemblies.

FIG. 10 is a perspective view of an improved modular jib assembly removably mountable to a boom lift with the addition of the MAD Barrier sub-assembly including a MAD conductor holder sub-assembly and two MAD articulating conductor holder sub-assemblies and two boom clamping sleeves with conductor holder sub-assemblies.

FIG. 11 is a perspective view of an improved modular jib assembly removably mountable to a boom lift with the addition of the MAD Barrier sub-assembly including a MAD electrically insulated telescopic support post sub-assembly and two MAD articulating conductor holder sub-assemblies and two boom clamping sleeves with conductor holder sub-assemblies.

FIG. 12 is a perspective view of an improved modular jib assembly removably mountable to a boom lift with the addition of the MAD Barrier sub-assembly including a MAD conductor holder sub-assembly, two MAD articulating telescopic insulating support post sub-assemblies and two boom clamping sleeves with electrically insulated telescopic support post sub-assemblies.

FIG. 13 is a perspective view of an improved modular jib assembly removably mountable to a boom lift with the addition of the MAD Barrier sub-assembly including a MAD electrically insulated telescopic support post sub-assembly, two MAD articulating telescopic insulating support post sub-assemblies and two boom clamping sleeves with electrically insulated telescopic support post sub-assemblies.

FIG. 14 is a perspective view of the components of the clamping sleeve with an electrically insulated telescopic support post sub-assembly.

FIG. 15 is a perspective view of the components of a boom clamping sleeve with conductor holder sub-assembly.

FIG. 16 is a perspective view of the components of a MAD electrically insulated telescopic support post sub-assembly.

FIG. 17 is a perspective view of the components of a MAD conductor holder sub-assembly.

FIG. 18 is a perspective view of the components of a MAD articulating telescopic insulating support post sub-assembly.

FIG. 19 is a perspective view of the components of a MAD articulating conductor holder sub-assembly.

FIG. 20 is a perspective view of the components of a MAD end socket polar array articulating conductor holder sub-assembly with MAD end socket pivot pin and MAD end socket position

### C. DETAILED DESCRIPTION OF THE DRAWINGS

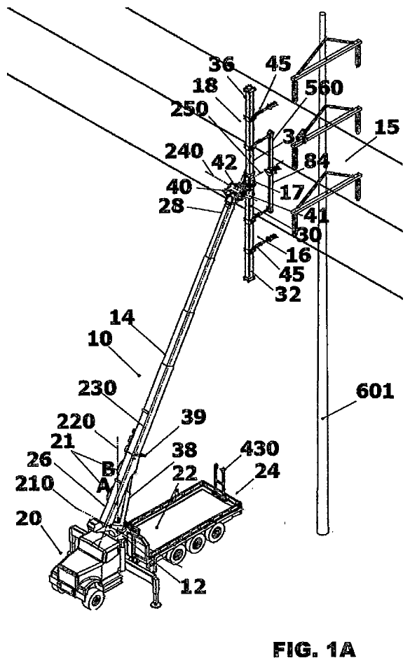

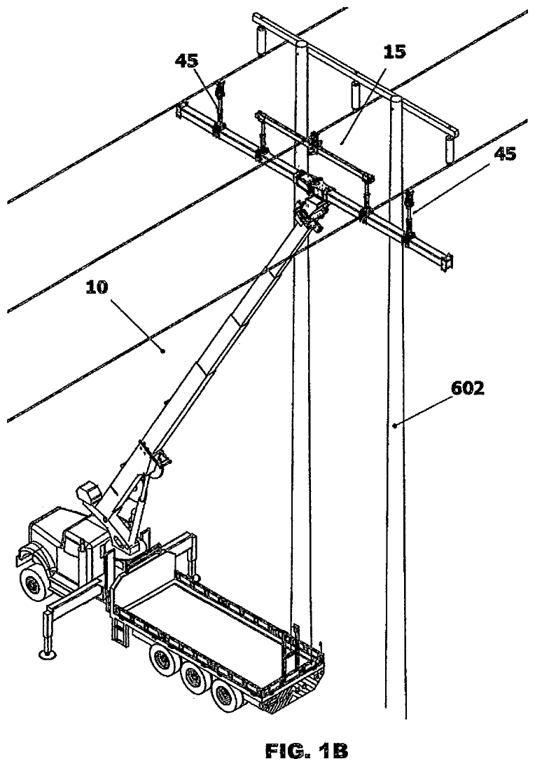

Referring to the drawings and first to FIG. 1A, a boom lift 10 is shown with the modular hot line jib assembly 15 in a vertical orientation. Said boom lift 10 generally includes a base 12, a first telescopic boom arm 14 and a second boom arm which in this example is a primary articulating jib sub-assembly 16, which is a sub-assembly of said modular hot line jib assembly 15. Said modular hot line jib assembly 15 also includes a secondary pin-on jib sub-assembly 18, MAD “Minimum Approach Distance” Barrier sub-assembly 84 and a boom clamping sleeve 91 with an electrically insulated telescopic support post sub-assembly 45. Said boom lift 10 is mounted on a vehicle 20 and, said base 12 of the boom lift is mounted on a flatbed 22 of the vehicle at a rear 24 thereof. Said boom lift 10 is rotatably and hingedly mounted to said vehicle 20 in this example. However, in other examples, said boom lift 10 may also have an articulation joint or be fixedly mounted on the vehicle.

Said boom lift 10 has a proximal end 26 and a distal end 28. Likewise, said primary articulating jib sub-assembly 16 has a proximal end 30 and a distal end 32 and said secondary pin-on jib sub-assembly 18 has a proximal end 34 and a distal end 36. Said proximal end 30 of said primary articulating jib sub-assembly 16 is hingedly coupled about a vertical pivot axis 250 to said proximal end 34 of said secondary pin-on jib sub-assembly 18 by a pair of coaxial mechanical fasteners (not shown) 142 connecting the primary boom base socket 41 with the secondary boom base socket 19. A second pair of coaxial mechanical fasteners (not shown) 143 fixedly couple said proximal end 30 of said primary articulating jib sub-assembly 16 to said proximal end 34 of said secondary pin-on jib sub-assembly 18.

Said proximal end 26 of said boom lift 10 is pivotably coupled to said base 12 in a. conventional manner and there is an actuator 38 which functions to pivot said boom lift 10 about a horizontal pivot axis 210. Said proximal end 26 of said boom lift 10 is also hingedly coupled to said base 12 in a conventional manner and there is a rotary actuator 42 (not shown) which functions to rotate said boom lift 10 about a vertical pivot axis 220. Hydraulic extension cylinders and cables within said boom lift 10 move said boom lift 10 between an extended position and a retracted position along extension axis 230.

Said modular hot line jib assembly 15 also comprises said primary articulating jib sub-assembly 16 which comprises a mounting bracket 40 mounted on said first telescopic boom arm 14 at said distal end 28 thereof. Said mounting bracket 40 supports a rotatory actuator 42 which, in this example, is in the form of said helical hydraulic rotary actuator 42. Said proximal end 30 of said primary articulating jib sub-assembly 16 is coupled to an output drive (not shown) of said rotary actuator 42. Said output drive imparts rotary motion to said primary articulating jib sub-assembly 16 such that said primary articulating jib sub-assembly 16 is pivotable about a horizontal pivot axis 240 which is substantially perpendicular to a longitudinal axis 230 of said first telescopic boom arm 14. Said proximal end 34 of said secondary pin-on jib sub-assembly 18 is hingedly connected to said proximal end 30 of said primary articulating jib sub-assembly 16 about said vertical pivot axis 250.

A boom rest 430 may be used to restrict movement of said distal end 28 of said boom lift 10 during transport and a support arm 39 may be used to restrict movement of the distal ends 32 and 36 of said primary articulating jib sub-assembly 16 and said secondary pin-on jib sub-assembly 18 when folded-under and side-stowed during transport.

Said modular hot line jib assembly 15 also comprises said MAD Barrier sub-assembly 84 which is releasably connected by clamping sleeves 91 to both said primary articulating jib sub-assembly 16 and said secondary pin-on jib sub-assembly 18. Said MAD Barrier sub-assembly 84 comprises two electrically insulated crossbeam sections 560 which are hingedly connected where the hinge is substantially at the mid-length position and of said MAD Barrier sub-assembly 84 and co-axial with said vertical pivot axis 250.

Said modular hot line jib assembly 15 also comprises said two boom clamping sleeves 91 with said electrically insulated telescopic support post sub-assemblies 45. One of the said two boom clamping sleeves 91 with said electrically insulated telescopic support post sub-assemblies 45 is releasably mounted on said primary articulating jib sub-assembly 16 and one is releasably mounted on said secondary pin-on jib sub-assembly 18.

Hydraulic pressure may be supplied to said rotary actuator 42 from the vehicle hydraulic pump and through hydraulic hoses routed alongside said first telescopic boom arm 14 on a hydraulic hose reel 21A or from a remote power source.

Said modular hot line jib assembly 15 is shown in position to support energised powerlines which are part of power pole assembly 601. Said primary articulating jib sub-assembly 16 and said secondary pin-on jib sub-assembly 18 are shown in a coaxial position with a vertical orientation. As shown, said MAD Barrier sub-assembly 84 prevents the energized conductors of said power pole assembly 601 from encroaching within the designated “MAD Distance” or “Minimum approach distance” to create an electrical path to ground down said first telescopic boom arm 14.

Referring to FIG. 1B, said boom lift 10 is shown with said modular hot line jib assembly 15 in a horizontal orientation. This orientation illustrates that said modular hot line jib assembly 15 as described in FIG. 1A is also suitable for supporting energised conductors in the horizontal configuration to align with energised conductors attached to power pole assembly 602 and multiple other configurations as owned by various power grid corporations. The spacing of the said two boom clamping sleeves 91 with said electrically insulated telescopic support post sub-assemblies 45 may be changed at ground level to align with the powerline spacing, but both configurations use the same components.

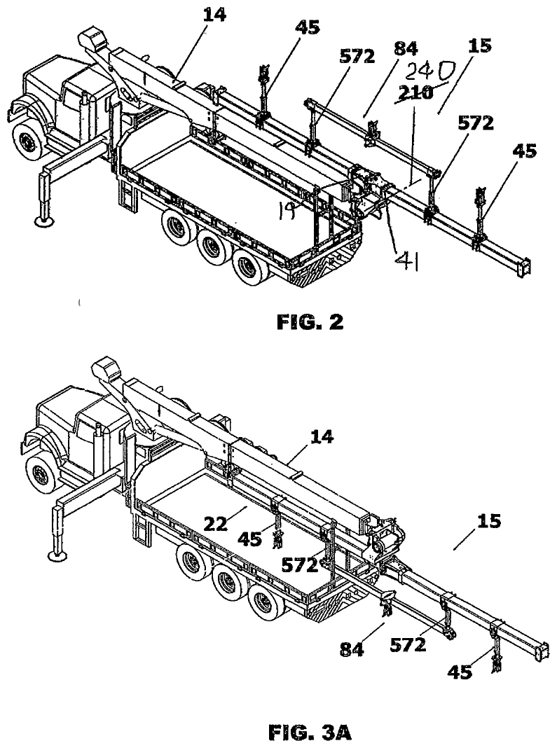

Referring now to FIG. 2, said first telescopic boom arm 14 is shown in the stowed position and said modular hot line jib assembly 15 of FIG. 1A is shown in the un-stowed position and rotated one hundred and eighty degrees from the horizontal stowed orientation around said pivot axis 240 and is ready to deploy. Said two boom clamping sleeves 91 with said electrically insulated telescopic support post sub-assemblies 45 and the MAD electrically insulated telescopic support post sub-assemblies 572 are all in extended position to ensure that said MAD Barrier sub-assembly 84 and clearances are maintained during operation.

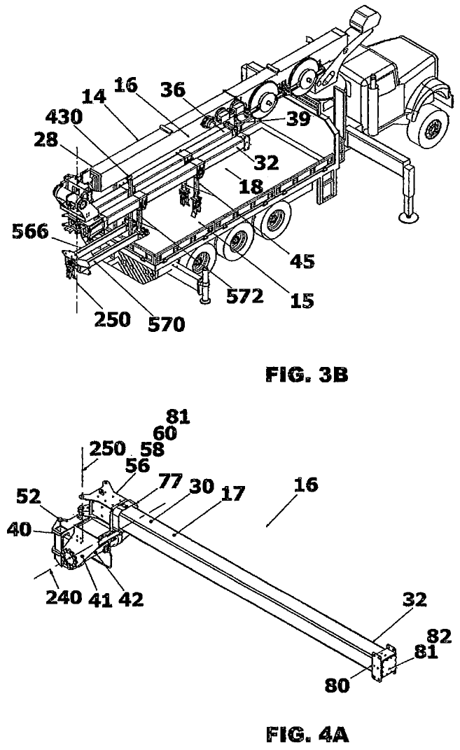

Referring now to FIG. 3A, said first telescopic boom arm 14 is shown in the stowed position and said modular hot line jib assembly 15 of FIG. 1A is shown in the horizontal stowed-under position and is ready to deploy. Said two boom clamping sleeves 91 with said electrically insulated telescopic support post sub-assemblies 45 and said MAD electrically insulated telescopic support post sub-assemblies 572 are all shown in the retracted position to illustrate that there is clearance between the retracted telescopic assemblies and said flatbed 22 and that there are no physical size or functionality constraints to prevent said modular hot line jib assembly 15 from stowing in this configuration.

Referring now to FIG. 3B, said first telescopic boom arm 14 is shown in the stowed position and said modular hot line jib assembly 15 is shown in the stowed-under and side-stowed position. Said two boom clamping sleeves 91 with said electrically insulated telescopic support post sub-assemblies 45 and said MAD electrically insulated telescopic support post sub-assemblies 572 are all shown in the retracted position. Said primary articulating jib sub-assembly 16 and said secondary pin-on jib sub-assembly 18 are shown in the folded-under and side-stowed position and ready for travel. The MAD electrically insulated outer crossbeam sub-assembly 566 is shown attached and stowed-under said primary articulating jib sub-assembly 16 and the MAD inner electrically insulated crossbeam sub-assembly 570 are shown attached and stowed-under said secondary pin-on jib sub-assembly 18. Said vertical pivot axis 250 is shown which is coaxial between the pivot of said primary articulating jib sub-assembly 16 and said secondary pin-on jib sub-assembly 18 and between said MAD outer electrically insulated crossbeam sub-assembly 566 and the MAD inner electrically insulated crossbeam sub-assembly 570. Said boom rest 430 is shown supporting and restricting movement of said distal end 28 of said first telescopic boom arm 14 during transport and said support arm 39 is shown supporting and restricting movement of the distal ends 32 and 36 of said primary articulating jib sub-assembly 16 and said secondary pin-on jib sub-assembly 18 when folded-under and side-stowed during transport.

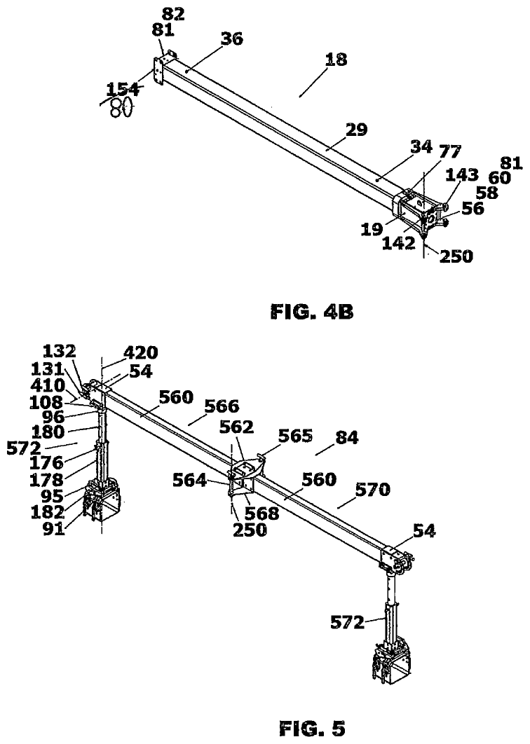

Referring now to FIG. 4A, said primary articulating jib sub-assembly 16 is shown in greater detail. Said primary articulating jib sub-assembly 16 comprises a mounting bracket 40 which is releasably mountable by four mounting pins primary adapter to boom 52 to the distal end 28 (not shown) as shown in FIG. 1A of the first telescopic boom arm 14 (not shown) as shown in FIG. 1A and also supports said rotary actuator 42 which, in this example, is in the form of said helical hydraulic rotary actuator 42. Said proximal end 30 of said primary articulating jib sub-assembly 16 is coupled to said output drive (not shown) of the rotary actuator 42. Said output drive of said rotary actuator 42 imparts motion to said primary boom base socket 41 and thereby imparts motion to said primary articulating jib sub-assembly 16 about horizontal pivot axis 240. Said primary boom base socket 41 also comprises four mounting pin locations for releasably mounting to the secondary boom base socket 19 (not shown) as shown in FIG. 4B of which two of the mounting pins 142 (not shown) as shown in FIG. 4B are spaced apart and coaxial about vertical pivot axis 250 and two additional mounting pins 143 (not shown) as shown in FIG. 4B are equally spaced apart and coaxial with each other. Said primary boom base socket 41 also receives said proximal end 30 of the primary boom 17. Said primary boom base socket 41 is secured to said primary boom 17 by a bolted and glued connection. Said primary boom base socket 41 is provided with an acrylic window desiccant 56 having an opening 58 for receiving a desiccant canister 60. Said acrylic window desiccant 56 is releasably secured to said primary boom base socket 41 by a bolted connection which compresses a seal 81 (not shown) to provide an environmentally resistant seal to prevent the ingress of dirt or moisture into the interior of said primary boom 17. Said desiccant canister 60, may be releasably coupled to said acrylic window desiccant 56 by mechanical threading. The purpose of said desiccant canister 60 is to allow air inside the primary boom 17 to expand and compress as well as to remove moisture which may have entered said primary boom 17.

Said primary articulating jib sub-assembly 16 also comprises a leakage monitoring shield 77 which is supported by a bolted connection to said primary boom base socket 41.

Said primary articulating jib sub-assembly 16 also comprises a primary boom end socket 80 at said distal end 32 of said primary articulating jib sub-assembly 16. Said primary boom end socket 80 is secured to said primary boom 17 by a bolted and glued connection. Said primary boom end socket 80 is provided with an acrylic window 82 that is releasably secured to said primary boom end socket 80 by a bolted connection which compresses said seal 81 (not shown) to provide an environmentally resistant seal. Said acrylic window 82 allows for easy inspection of an interior of said primary boom 17.

Referring now to FIG. 4B, said secondary pin-on jib sub-assembly 18 is shown in greater detail. Said secondary pin-on jib sub-assembly 18 is comprised of said secondary jib base socket 19 which receives said proximal end 34 of the secondary boom 29. Said secondary jib base socket 19 is secured to said secondary boom 29 by a bolted and glued connection. Said secondary jib base socket 19 is provided with said acrylic window desiccant 56 having said opening 58 for receiving said desiccant canister 60. Said acrylic window desiccant 56 is releasably secured to said secondary jib base socket 19 by a bolted connection which compresses said seal 81 (not shown) to provide an environmentally resistant seal to prevent the ingress of dirt or moisture into the interior of said primary boom 17. Said desiccant canister 60, may be releasably coupled to said acrylic window desiccant 56 by mechanical threading.

Said secondary boom base socket 19 also comprises four mounting pin locations for releasably mounting to the primary boom base socket 41 of which two of the mounting pins 142 are spaced apart and coaxial about vertical pivot axis 250 and two additional mounting pins 143 are equally spaced apart and coaxial with each other.

Said secondary pin-on jib sub-assembly 18 also comprises a secondary boom end socket 80 at said distal end 36 of said secondary pin-on jib sub-assembly 18. Said secondary boom end socket 80 is fixedly attached to said secondary boom 29 by a bolted and glued connection. Said secondary boom end socket 80 is provided with said acrylic window 82 that is releasably secured to said primary secondary boom end socket 80 by a bolted connection which compresses said seal 81 (not shown) to provide an environmentally resistant seal. Said acrylic window 82 allows for easy inspection of an interior of said secondary boom 29.

Referring now to FIG. 5, said MAD Barrier sub-assembly 84 is comprised of two said MAD electrically insulated telescopic support post sub-assemblies 572 releasably attached to two electrically insulating crossbeam sub-assemblies. Said electrically insulated crossbeam sub-assemblies are designated as one said MAD inner electrically insulated crossbeam sub-assembly 570 and one said MAD outer electrically insulated crossbeam sub-assembly 566. Said electrically insulated crossbeam sections sub-assemblies are pivotably attached at the midpoint about said vertical pivot axis 250 which coaxially corresponds with said vertical pivot axis 250 between said primary boom base socket 41 and said secondary jib base socket 19 (not shown), both as shown in FIG. 1A FIG. 2. The lengths of said electrically insulating crossbeam sub-assemblies may extend beyond the MAD clearance distance requirements per work site requirements.

Each said MAD electrically insulated telescopic support post sub-assemblies 572 is comprised of said boom clamping sleeve 91 which is releasably connected to either said primary boom 17 (not shown) as shown on FIG. 2 of said primary articulating jib sub-assembly 16 (not shown) as shown on FIG. 2 or to said secondary boom 29 (not shown) as shown on FIG. 2 of said secondary pin-on jib sub-assembly 18 (not shown) as shown on in FIG. 2. Said two boom clamping sleeves 91 are positioned with substantially equal spacing from their respective leakage monitoring shields 77 (not shown) as shown in FIG. 2 which is equal to or exceeds the phase to ground MAD distance as listed in the appropriate electrical standard.

Each of said boom clamping sleeves 91 of said MAD electrically insulated telescopic support post sub-assemblies 572 are releasably connected at their proximal end to a socket outer support post 182 which is fixedly attached to an electrically insulating outer support post 178 by a two-pin connector clamping sleeve 95 equipped with pin retainers. Said electrically insulating outer support post 178 is slidably coupled and selectively adjustable to an electrically insulating inner support post 180 along a longitudinal extension axis 420 with a plurality of positioning holes in said electrically insulating inner support post 180. Said electrically insulating inner support post 180 is configured to selectively engage one or more of the positioning holes with a positioning pin 176. Alternatively, suitable mechanical actuators may also be provided to perform said telescopic function.

Said electrically insulating inner support post 180 is fixedly attached at the distal end to a distal adapter plate 96. Said distal adapter plate 96 is releasably attached to a MAD end socket polar array 54 by a two-pin connector conductor holder 108 equipped with pin retainers.

Said MAD end socket polar array 54 is shown in greater detail in FIG. 20 and may be fixedly attached by a bolted and glued connection to the distal end of the electrically insulated crossbeam of either MAD inner electrically insulated crossbeam sub-assembly 570 or said MAD outer electrically insulated crossbeam sub-assembly 566. Said MAD end socket polar array 54 includes a substantially horizontal axis of rotation 410 extending substantially laterally across said electrically insulated crossbeam section 560 and equipped with a plurality of holes to allow attachments to be pivotably attached to said MAD end socket polar array 54 by a MAD end socket pivot pin 131 equipped with a pin retainer and positionally located by a MAD end socket position pin 132 equipped with a pin retainer relative to said electrically insulated crossmember section 560 in a substantially vertical plane. Alternatively, suitable mechanical actuators may also be provided to perform said rotation function about said substantially horizontal axis of rotation 410.

Said MAD electrically insulated telescopic support post sub-assemblies 572 allow vertical movement of said MAD electrically insulating crossbeam sub-assemblies 566 and 570 to the recommended MAD clearance distance from said primary boom base socket 41 (not shown) as shown in FIG. 2 which eliminates the possibility of said electrical path to ground through said first telescopic boom arm 14 (not shown) as shown in FIG. 2. Said MAD electrically insulating crossbeam sub-assemblies 566 and 570 also provide a physical barrier to prevent any energised conductors from encroaching within said MAD clearance region and they also increase the phase-to-phase leakage distance for additional voltage leakage safety. Said MAD electrically insulated telescopic support post sub-assemblies 572 also retract to minimise the overall height of said MAD electrically insulating crossbeam sub-assemblies 566 and 570 and allow storage under said first telescopic boom arm 14 (not shown) for travel as shown in FIG. 3B. Said retraction function avoids the requirement for removal of said MAD Barrier sub-assembly 84 due to physical size and shape constraints.

Said MAD Barrier sub-assembly 84 also comprises two electrically insulating crossbeam sub-assemblies said MAD inner electrically insulated crossbeam sub-assembly 570 and said MAD outer electrically insulated crossbeam sub-assembly 566. Said MAD inner electrically insulated crossbeam sub-assembly 570 offset pivot is comprised of said electrically insulating crossbeam section 560 and a MAD inner pivot socket 568 and said MAD outer electrically insulated crossbeam sub-assembly 566 offset pivot is comprised of said electrically insulating crossbeam section 560 and a MAD outer pivot socket 562.

Said MAD inner pivot socket 568 is comprised of a socket containing an upper and lower pivot plate, two side plates and an end plate. Said MAD inner pivot socket 568 is fixedly attached by a bolted and glued connection to said MAD inner electrically insulated crossbeam sub-assembly 570. Said MAD outer pivot socket 562 is comprised of a socket containing an upper and lower pivot plate, two side plates, an end plate and a two-pin mount is located on the upper pivot plate. Said MAD outer pivot socket 562 is fixedly attached by a bolted and glued connection to said MAD outer electrically insulated crossbeam sub-assembly 566.

Said electrically insulating crossbeam sub-assemblies 566 and 570 are pivotably connected by a MAD pivot pin with a retainer 564 at said vertical pivot axis 250 at the midpoint of said MAD Barrier sub-assembly 84. Said vertical pivot axis 250 is in vertical alignment with said vertical pivot axis 250 between said primary articulating jib sub-assembly 16 (not shown) as shown in FIG. 2 and said secondary pin-on jib sub-assembly 18 (not shown) as shown in FIG. 2. Said vertical pivot joint at said vertical pivot axis 250 may be positionally located by a MAD position pin with a retainer 565 to maintain a coaxial orientation between said electrically insulated crossmembers sections 560.

Said second pair of coaxial mechanical fasteners 143 between said primary articulating jib sub-assembly 16 (not shown) as shown in FIG. 4B and said secondary pin-on jib sub-assembly 18 (not shown) as shown in FIG. 4B on said vertical pivot axis 250 as shown in FIG. 4B, and the MAD position pin with a retainer 565 between said MAD inner electrically insulated crossbeam sub-assembly 570 and said MAD outer electrically insulated crossbeam sub-assembly 566 are coaxial and must be removed at the same time to allow said secondary pin-on jib sub-assembly 18 (not shown) as shown in FIG. 4B to pivot 180 degrees around said vertical pivot axis 250 and stow beside said primary articulating jib sub-assembly 16 (not shown) as shown in FIG. 3B. Once stowed, the proximal ends 34 and 30 respectively of both jib sub-assemblies are releasably secured by said boom rest 430 at the rear of the flat deck and the distal ends of both jib sub-assemblies are releasably secured to said support arm 39 as shown in FIG. 3B.

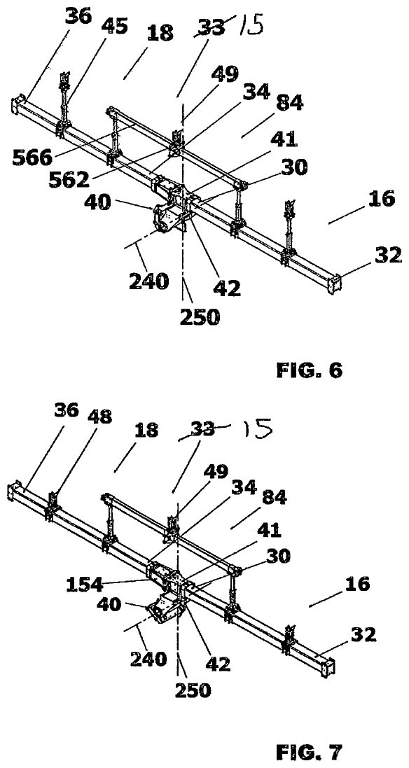

In the first embodiment, shown in FIG. 6, said modular hot line jib assembly 15 is comprised of said primary articulating jib sub-assembly 16 and said secondary pin-on jib sub-assembly 18 and said MAD Barrier sub-assembly 84 as described above.

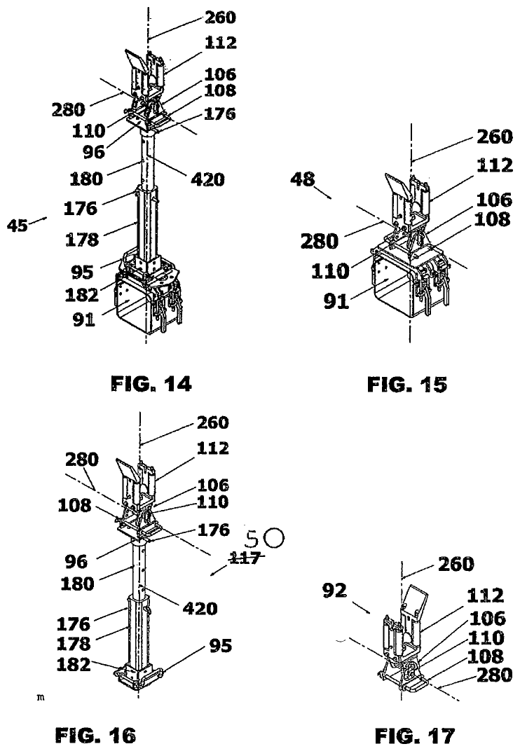

In the first embodiment of said modular hot line jib assembly 15 as shown in FIG. 6 is also comprised of said two boom clamping sleeves 91 with an electrically insulated telescopic support post sub-assemblies 45. Said two boom clamping sleeves 91 with said electrically insulated telescopic support post sub-assemblies 45 are further described in FIG. 14 and are comprised of said boom clamping sleeve 91 which may be releasably mounted at the proximal end to said socket outer support post 182 by said two pin connector clamping sleeve 95 equipped with pin retainers.

Said socket outer post 182 is fixedly attached to said electrically insulating outer support post 178. Said electrically insulating outer support post 178 is slidably coupled and selectively adjustable to said electrically insulating inner support post 180 along said longitudinal extension axis 420 with a plurality of positioning holes in said electrically insulating inner support post 180. Said electrically insulating inner support post 180 is configured to selectively engage one or more of the positioning holes with said positioning pin 176. Alternatively, suitable mechanical actuators may also be provided to perform said telescopic function along said longitudinal extension axis 420.

Said electrically insulating inner support post 180 is fixedly attached at the distal end to said distal adapter plate 96. Said distal adapter plate 96 is releasably attached to a support bracket 106 by a two-pin connector conductor holder 108 equipped with pin retainers. Said support bracket 106 is pivotably attached to a conductor holder means 112 by a bearing (not shown) on a vertical axis conductor holder 260. Said support bracket 106 includes a horizontal tilt axis support bracket 280 equipped with a plurality of holes to allow said support bracket 106 to be positionally located by a position pin 110 relative to said primary articulating jib sub-assembly 16 (not shown) as shown in FIG. 6 and said secondary pin-on jib sub-assembly 18 (not shown) as shown in FIG. 6 in a substantially vertical plane.

In the first embodiment of said modular hot line jib assembly 15 as shown in FIG. 6 is also comprised of a MAD conductor holder sub-assembly 49. Said MAD conductor holder sub-assembly 49 is releasably attached through the two-pin mount located on the upper pivot plate of said MAD outer pivot socket 562 by said two-pin connector equipped with pin retainers 108. Said MAD conductor holder sub-assembly 49 is further described in FIG. 17 and is further comprised of said support bracket 106 which is pivotably attached to said conductor holder means 112 by a bearing (not shown) on said vertical axis conductor holder 260. Said support bracket 106 includes a horizontal tilt axis support bracket 280 equipped with a plurality of holes to allow said support bracket 106 to be positionally located by a position pin 110 relative to said MAD outer electrically insulated crossbeam section sub-assembly 566 in a substantially vertical plane.

In the second embodiment, shown in FIG. 7, said modular hot line jib assembly 15 is comprised of said primary articulating jib sub-assembly 16 and said secondary pin-on jib sub-assembly 18, said MAD Barrier sub-assembly 84 and said MAD conductor holder sub-assembly 49 as described above.

In a second embodiment, shown in FIG. 7, said modular hot line jib assembly 15 is also comprised of said two boom clamping sleeves 91 with said two conductor holder sub-assemblies 48. Said two boom clamping sleeves 91 with said two conductor holder sub-assemblies 48 are further described in FIG. 15 and are also comprised of said boom clamping sleeve 91 which is releasably attached by said two-pin connector clamping sleeve 108 equipped with pin retainers to said support bracket 106. Said support bracket 106 is equipped with said horizontal tilt axis support bracket 280 which is laterally across said primary articulating jib sub-assembly 16 (not shown) as shown in FIG. 7 and said secondary pin-on jib sub-assembly 18 (not shown) as shown in FIG. 7 and parallel to said horizontal pivot axis 240 (not shown) as shown in FIG. 7 for articulation of said support bracket 106 in a substantially vertical plane.

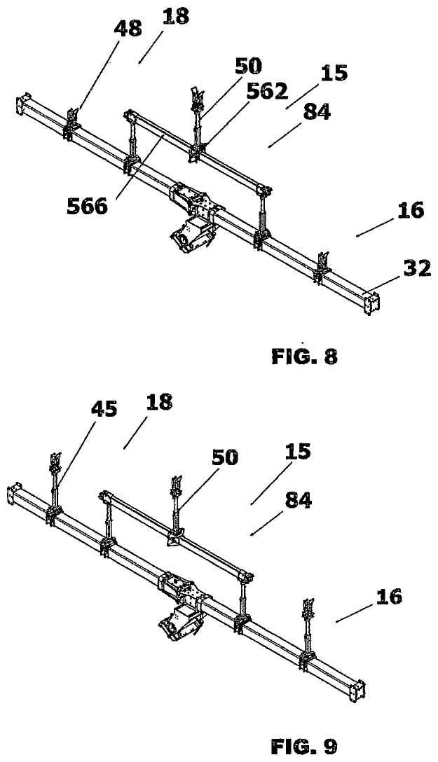

In the third embodiment, shown in FIG. 8, said modular hot line jib assembly 15 is comprised of said primary articulating jib sub-assembly 16 and said secondary pin-on jib sub-assembly 18 and said MAD Barrier sub-assembly 84 and said two boom clamping sleeves 91 with said two conductor holder sub-assemblies 48 as described above.

Said MAD outer pivot socket 562 is releasably attached through the two-pin mount located on the upper pivot plate to a MAD electrically insulated telescopic support post sub-assembly 50 by said two pin connector clamping sleeve 95 equipped with pin retainers. Said MAD electrically insulated telescopic support post sub-assembly 50 is further described in FIG. 16 and is comprised of said socket outer support post 182 which is fixedly attached to said electrically insulating outer support post 178. Said electrically insulating outer support post 178 is slidably coupled and selectively adjustable to said electrically insulating inner support post 180 along said longitudinal extension axis 420 with a plurality of positioning holes in said electrically insulating inner support post 180. Said electrically insulating inner support post 180 is configured to selectively engage one or more of the positioning holes with said positioning pin 176. Alternatively, suitable mechanical actuators may also be provided to perform said telescopic function.

Said electrically insulating inner support post 180. is fixedly attached at the distal end to said distal adapter plate 96. Said distal adapter plate 96 is releasably attached to said support bracket 106 by said two-pin connector conductor holder 108 equipped with pin retainers. Said support bracket 106 is pivotably attached to said conductor holder means 112 by a bearing (not shown) on said vertical axis conductor holder 260. Said support bracket 106 includes said horizontal tilt axis support bracket 280 equipped with a plurality of holes to allow said support bracket 106 to be positionally located by said position pin 110 relative to said MAD outer electrically insulated crossbeam section sub-assembly 566 (not shown) as shown in FIG. 8 in a substantially vertical plane.

In the fourth embodiment, shown in FIG. 9, said modular hot line jib assembly 15 is comprised of said primary articulating jib sub-assembly 16 and said secondary pin-on jib sub-assembly 18 and said MAD Barrier sub-assembly 84, said two boom clamping sleeves 91 with said electrically insulated telescopic support post sub-assemblies 45 as described above and said MAD electrically insulated telescopic support post sub-assembly 50 as described above.

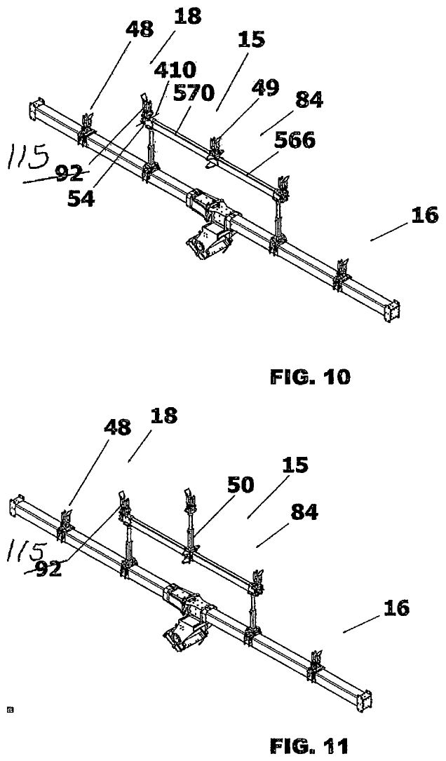

In the fifth embodiment, shown in FIG. 10, said modular hot line jib assembly 15 is comprised of said primary articulating jib sub-assembly 16 and said secondary pin-on jib sub-assembly 18 and said MAD Barrier sub-assembly 84, said two boom clamping sleeves 91 with said two conductor holder sub-assemblies 48 and said MAD conductor holder sub-assembly 49 as described above.

Said fifth embodiment is also comprised of said two MAD articulating conductor holder sub-assemblies 115 as further described in FIG. 19. Said two MAD articulating conductor holder sub-assemblies 115 are comprised of an articulating support tube 145 which is releasably attached by said MAD end socket pivot pin with a retainer 131 (not shown) as shown in FIG. 20 to said MAD end socket polar array 54 as further described in FIG. 20. Said MAD articulating conductor holder sub-assemblies 115 are positionally located about said substantially horizontal axis of rotation 410 by said MAD end socket position pin 132 (not shown) as shown in FIG. 20 equipped with a pin retainer relative to said MAD electrically insulated crossmember sub-assemblies 566 and 570 in a substantially vertical plane. Alternatively, suitable mechanical actuators may also be provided to perform said rotation function about said substantially horizontal axis of rotation 410.

Said articulating support tube 145 of the MAD articulating conductor holder sub-assemblies 115 is releasably attached to said support bracket 106 by said two-pin connector conductor holder 108 equipped with pin retainers. Said support bracket 106 is pivotably attached to said conductor holder means 112 by a bearing (not shown) on said vertical axis conductor holder 260. Said support bracket 106 includes said horizontal tilt axis support bracket 280 equipped with a plurality of holes to allow said support bracket 106 to be positionally located by said position pin 110 relative to said MAD outer electrically insulated crossbeam section sub-assembly 566 and MAD inner electrically insulated crossbeam sub-assembly 570 in a substantially vertical plane. Alternatively, suitable mechanical actuators may also be provided to perform said rotation function about said substantially horizontal axis of rotation 410.

In the sixth embodiment, shown in FIG. 11, said modular hot line jib assembly 15 is comprised of a primary articulating jib sub-assembly 16 and said secondary pin-on jib sub-assembly 18 and said MAD Barrier sub-assembly 84, said two MAD articulating conductor holder sub-assemblies 115 said two boom clamping sleeves 91 with said two conductor holder sub-assemblies 48 and a said MAD electrically insulated telescopic support post sub-assembly 50 as described above.

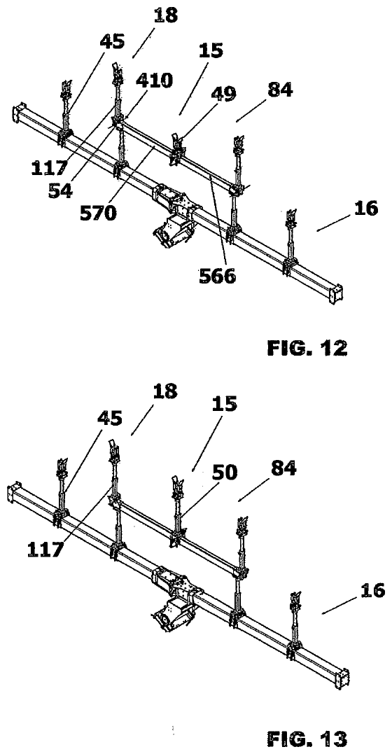

In the seventh embodiment, shown in FIG. 12, said modular hot line jib assembly 15 is comprised of said primary articulating jib sub-assembly 16 and said secondary pin-on jib sub-assembly 18 and said MAD Barrier sub-assembly 84, said two boom clamping sleeves 91 with said electrically insulated telescopic support post sub-assemblies 45 and said MAD conductor holder sub-assembly 49 as described above.

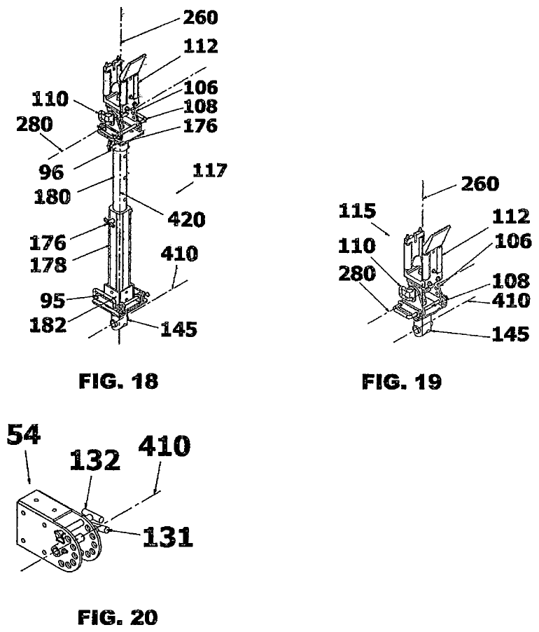

Said seventh embodiment is also comprised of said two MAD articulating telescopic insulating support post sub-assemblies 117 as described in FIG. 18. Each of said MAD articulating telescopic insulating support post sub-assemblies 117 are comprised of said articulating support tube 145 which is releasably attached by said MAD end socket pivot pin equipped with a pin retainer 131 (not shown) as shown in FIG. 20 to said MAD end socket polar array 54 (not shown) as shown in FIG. 20. Said MAD articulating telescopic insulating support post sub-assemblies 117 are positionally located about said substantially horizontal axis of rotation 410 by said MAD end socket position pin 132 (not shown) as shown in FIG. 20 equipped with a pin retainer relative to said MAD outer electrically insulated crossmember sub-assemblies 566 and MAD inner electrically insulated crossbeam sub-assembly 570 in a substantially vertical plane. Alternatively, suitable mechanical actuators may also be provided to perform said rotation function about said substantially horizontal axis of rotation 410.

Said articulating support tube 145 of the MAD articulating telescopic insulating support post sub-assemblies 117 is releasably attached at their proximal end to said socket outer support post 182 which is fixedly attached to said electrically insulating outer support post 178 by said two pin connector clamping sleeve 95 equipped with pin retainers. Said electrically insulating outer support post 178 is slidably coupled and selectively adjustable to said electrically insulating inner support post 180 along said longitudinal extension axis 420 with a plurality of positioning holes in said electrically insulating inner support post 180. Said electrically insulating inner support post 180 is configured to selectively engage one or more of the positioning holes with said positioning pin 176. Alternatively, suitable mechanical actuators may also be provided to perform said telescopic function.

Said electrically insulating inner support post 180 is releasably attached at the distal end to said distal adapter plate 96. Said distal adapter plate 96 is releasably attached to said support bracket 106 by said two-pin connector conductor holder 108 equipped with pin retainers. Said support bracket 106 is pivotably attached to said conductor holder means 112 by a bearing (not shown) on said vertical axis conductor holder 260. Said support. bracket 106 includes said horizontal tilt axis support bracket 280 equipped with a plurality of holes to allow said support bracket 106 to be positionally located by said position pin 110 relative to said MAD outer electrically insulated crossbeam section sub-assembly 566 and MAD inner electrically insulated crossbeam sub-assembly 570 in a substantially vertical plane,

In the eighth embodiment, shown in FIG. 13, said modular hot line jib assembly 15 is comprised of said primary articulating jib sub-assembly 16 and said secondary pin-on jib sub-assembly 18, said MAD Barrier sub-assembly 84, said two boom clamping sleeves 91 with said electrically insulated telescopic support post sub-assemblies 45, said MAD electrically insulated telescopic support post sub-assembly 50 and said MAD articulating telescopic insulating support post sub-assemblies 117 as described above.

What is claimed is:

1. Claim 1 comprises a boom mountable modular hot line jib assembly which may be releasably attached to the distal end of a boom lift. Said modular hot line jib assembly is comprised of:
an electrically insulating primary jib sub-assembly that is pivotably coupled about a first axis of rotation which extends laterally of and between said electrically insulating primary jib sub-assembly and the distal end of said boom lift for rotational movement, by rotational actuating means which is selectively and remotely actuable in a vertical plane relative to said boom lift,
an electrically insulating secondary pin-on jib sub-assembly which may be releasably and pivotably coupled and adjustable about a second axis of rotation which is substantially orthogonal to said electrically insulating primary jib sub-assembly and which is substantially vertical when said electrically insulating primary jib sub-assembly is horizontal for rotation of the electrically insulating secondary pin-on jib sub-assembly about said substantially orthogonal axis,
a primary boom end socket fixedly mounted to the distal end of the electrically insulating jib primary boom including multiple mounting holes for releasably mounting optional energized conductor handling tools,
a secondary boom end socket fixedly mounted to the distal end of the electrically insulated secondary boom including multiple mounting holes for releasably mounting optional energized conductor handling tools,
a MAD electrically insulated telescopic support post sub-assembly releasably mounted to said electrically insulating jib primary boom at the proximal end and releasably mounted to an electrically insulated MAD outer crossbeam section at the distal end, comprising telescopic means for temporary support of the MAD outer electrically insulated crossbeam section,
a MAD electrically insulated telescopic support post sub-assembly releasably mounted to said electrically insulated jib secondary boom at the proximal end and releasably mounted to an electrically insulated MAD inner crossbeam section at the distal end, comprising telescopic means for temporary support of the MAD inner electrically insulated crossbeam section,
said MAD electrically insulated telescopic support posts include a clamping sleeve releasably connected to an electrically insulated outer support post which is slidably coupled along a longitudinal axis and selectively adjustable to the electrically insulated inner support post to accommodate length adjustments by selectively engaging one or more of the positioning holes with a positioning pin,
a single orthogonal axis of rotation which is coaxial, and which may be releasably and pivotably coupled and releasably lockable about said second axis of rotation and substantially orthogonal to said electrically insulated MAD outer crossbeam section and which is substantially vertical when said electrically insulated MAD outer crossbeam section is horizontal for rotation of the electrically insulated MAD inner crossbeam section about said orthogonal second axis of rotation,
a single two pin mount on the top of the MAD outer pivot socket of the MAD outer electrically insulated crossbeam section,
a single third axis of rotation extending substantially laterally across the distal end of said electrically insulated MAD outer crossbeam section for rotation relative to said electrically insulated MAD outer crossbeam section in a vertical plane about said orthogonal axis. Said third axis of rotation is equipped with a plurality of holes to allow energized conductor handling tools to be releasably and pivotably mounted and positionally located by a pivoting pin and a positional pin substantially in a vertical plane, and
a single fourth axis of rotation extending substantially laterally across the distal end of said electrically insulated MAD inner crossbeam section for rotation of releasably and pivotably mounted energized conductor handling tools relative to said electrically insulated MAD inner crossbeam section in a vertical plane about said orthogonal axis. Said fourth axis of rotation is equipped with a plurality of holes to allow energized conductor handling tools to be releasably and pivotably mounted and positionally located by a pivoting pin and a positional pin substantially in a vertical plane.

2. Claim 2 comprises a boom mountable modular hot line jib assembly of claim 1 further comprising at least one form of conductor support means chosen from the following:
a) a MAD conductor holder sub-assembly releasably and pivotably attached to the MAD outer pivot socket of the MAD outer electrically insulated crossbeam section, comprising pivoting and tilting conductor holding means for temporarily supporting an energized electrical conductor,
b) a MAD electrically insulated telescopic support post sub-assembly releasably attached to the MAD outer pivot socket of the MAD outer electrically insulated crossbeam section, comprising telescopic, pivoting, and tilting conductor holding means for temporarily supporting an energized electrical conductor,
c) one pin-on articulating conductor holder sub-assembly releasably and pivotably mounted on said third axis of rotation extending substantially laterally across the distal end of said electrically insulated MAD outer crossbeam section, comprising pivoting and tilting conductor holding means for temporarily supporting an energized electrical conductor,
d) one pin-on articulating conductor holder sub-assembly releasably and pivotably mounted on said fourth axis of rotation extending substantially laterally across the distal end of said electrically insulated MAD inner crossbeam section, comprising pivoting and tilting conductor holding means for temporarily supporting an energized electrical conductor,
e) one MAD articulating telescopic insulating support post sub-assembly releasably and pivotably mounted on said third axis of rotation extending substantially laterally across the distal end of said electrically insulated MAD outer crossbeam section comprising telescopic, pivoting, and tilting conductor holding means for temporarily supporting an energized electrical conductor,
f) one MAD articulating telescopic insulating support post sub-assembly releasably and pivotably mounted on said fourth axis of rotation extending substantially laterally across the distal end of said electrically insulated MAD inner crossbeam section comprising telescopic, pivoting, and tilting conductor holding means for temporarily supporting an energized electrical conductor,
g) one or more boom clamping sleeves with electrically insulated telescopic support post sub-assemblies releasably mounted on said electrically insulating primary jib sub-assembly comprising telescopic, pivoting, and tilting conductor holding means for temporarily supporting an energized electrical conductor,
h) one or more boom clamping sleeves with electrically insulated telescopic support post sub-assemblies releasably mounted on said electrically insulating secondary pin-on jib sub-assembly comprising telescopic, pivoting, and tilting conductor holding means for temporarily supporting an energized electrical conductor,
i) one or more boom clamping sleeves with conductor holder sub-assemblies releasably mounted on said electrically insulating primary jib sub-assembly, comprising pivoting and tilting conductor holding means for temporarily supporting an energized electrical conductor,
j) one or more boom clamping sleeves with conductor holder sub-assemblies releasably mounted on said electrically insulating secondary pin-on jib sub-assembly, comprising pivoting and tilting conductor holding means for temporarily supporting an energized electrical conductor.

3. Claim 3 comprises a boom mountable modular hot line jib assembly of claim 2 further comprising seals, windows, and a desiccant with visual moisture display to control moisture and prevent contamination inside the electrically insulating jib primary boom and secondary boom and a leakage monitoring system fixedly mounted to both the electrically insulating primary jib sub-assembly and the electrically insulating secondary pin-on jib sub-assembly with digital readout and settable alarm at the operator station.

4. Claim 4 comprises a boom mountable modular hot line jib assembly of claim 3 further comprising a hydraulic pressure monitoring system measuring hydraulic pressure on both sides of the pivotal actuating means with digital readout and settable alarm at the operator station.

5. Claim 5 comprises a boom mountable modular hot line jib assembly of claim 4 further comprising a rotary actuator which is selectively and remotely actuable and rotates said electrically insulating secondary pin-on jib sub-assembly and said electrically insulated MAD inner crossbeam section one hundred and eighty degrees around said a second axis of rotation in relation to the primary boom base socket.

6. Claim 6 comprises a boom mountable modular hot line jib assembly of claim 5 further comprising a rotary actuator which is selectively and remotely actuable, and which rotates the MAD articulating telescopic insulating support post sub-assembly one hundred and eighty degrees about the third axis of rotation in relation to the electrically insulated MAD outer crossbeam section.

7. Claim 7 comprises a boom mountable modular hot line jib assembly of claim 5 further comprising a rotary actuator which is selectively and remotely actuable, and which rotates the MAD articulating telescopic insulating support post sub-assembly one hundred and eighty degrees about the fourth axis of rotation in relation to the electrically insulated MAD inner crossbeam section.

8. Claim 8 comprises a boom mountable modular hot line jib assembly of claim 5 further comprising a telescopic actuator which is selectively and remotely actuable for actuating telescopic movement of MAD electrically insulated telescopic support post sub-assemblies along a longitudinal axis.

9. Claim 9 comprises a boom mountable modular hot line jib assembly of claim 5 further comprising a telescopic actuator which is selectively and remotely actuable for actuating telescopic movement of boom clamping sleeves with electrically insulated telescopic support post sub-assemblies along a longitudinal axis.

10. Claim 10 comprises a boom mountable modular hot line jib assembly of claim 5 further comprising a telescopic actuator which is selectively and remotely actuable for actuating telescopic movement of MAD articulating electrically insulated telescopic insulating support post sub-assembly along a longitudinal axis.

11. Claim 11 comprises the modular hot line jib assembly of claim 1 wherein the boom adapter of the primary articulating jib sub-assembly is comprised of an electrically insulating material configured to hinder the conduction of electrical current through said components.

12. Claim 12 comprises the modular hot line jib assembly of claim 1 wherein the mounting bracket of the primary articulating jib sub-assembly is comprised of an electrically insulating material configured to hinder the conduction of electrical current through said components.

13. Claim 13 comprises the modular hot line jib assembly of claim 1 wherein the primary boom base socket of the primary articulating jib sub-assembly is comprised of an electrically insulating material configured to hinder the conduction of electrical current through said components.

14. Claim 14 comprises the modular hot line jib assembly of claim 1 wherein the secondary base socket of the secondary pin-on jib sub-assembly is comprised of an electrically insulating material configured to hinder the conduction of electrical current through said components.

15. Claim 15 comprises the modular hot line jib assembly of claim 1 which is accordingly provided with a sensor for determining an angular position thereof. The sensor is in the form of an inclinometer but may be any suitable sensor. The inclinometer signals an angular position of the modular hot line jib assembly to the operator control panel.

16. Claim 16 comprises the modular hot line jib assembly of claim 1 which is accordingly provided with a radio remote control which operates all actuable functions of the boom lift and modular hot line jib assembly independently.
